(19) United States
(12) Patent Application Publication
(10) Pub. No.: US 2025/0282606 A1
(43) Pub. Date: Sep. 11, 2025

(54) Method and Device for Training Horses

(71) Applicant: Jean Philippe Giacomini, Harrodsburg, KY (US)

(72) Inventor: Jean Philippe Giacomini, Harrodsburg, KY (US)

(21) Appl. No.: 18/922,773

(22) Filed: Oct. 22, 2024

Related U.S. Application Data
(60) Provisional application No. 63/545,188, filed on Oct. 22, 2023.

(51) Int. Cl. B68B 1/02; A01K 15/02

(52) U.S. Cl. CPC B68B 1/02; A01K 15/02

(57) ABSTRACT

A modified halter for a horse, the halter having a headpiece having a specialized component that presses against and stimulates the vagus nerve of the animal. The specialized component is a curved piece of material that is attached to the headpiece under the horses head and positioned against the vagus nerve. The stimulates mouth activity in the horse, which has a known calming effect. This calming effect aids in training the animal. The invention also includes unique rope configurations attached to the headpiece and the saddle that hang over the shoulders of the animal and further stimulate and calm the animal to aid in training. The invention also includes methods of using the modified halter to train the animal.

### CROSS REFERENCE TO RELATED APPLICATIONS

This application claims priority to U.S. provisional application Ser. No. 63/545,188 filed on Oct. 22, 2023, and fully incorporated herein by reference.

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC

Not Applicable

### BACKGROUND OF THE INVENTION

### Field of the Invention

The present invention relates to a device use for training horses, and a method of using the device to train horses. The device consists of a modified halter with a component that stimulates the vagus nerve of the horse to trigger mouth activity that relaxes the animal to aid in training.

### Description of the Related Art

The primary current methodology is to train horses to convince them to go forward on demand. Traditionally, the “impulsion” of the horse is characterized as “the desire to go forward on demand.” It is the basis of horse management and training and nothing can be achieved with a horse if the horse is not convinced to move forward on demand at a controllable speed. Impulsion has been traditionally attributed to the driving power of the back end. The number one resistance in horses' training is characterized as the refusal to go forward when asked by the rider's impulsive aids (voice, legs, seat, whip). The horse resists the demands in a number of ways: by locking the knees (“Stay Apparatus” that stiffens the legs during stance and just before each foot is landing); by inverting the neck and raising the head; by bracing the feet on the ground, and by locking the jaw and keeping the mouth dry (sign of stress). The majority of incidents considered by the public to be horse abuse happen when the rider/trainer applies ineffective techniques designed to make the horse go forward. Those traditional techniques are focused on pushing the horse's back end from behind (usually with some form of whip), on the false logic “that's where is engine is located.” In reality, impulsion can only occur when the resistances of the front end (“bracing” during stance) are eliminated or avoided altogether.

It is important to understand impulsion through ethology, which is the study the horse's natural behavior, or ethogram. The natural impulsion of the horse is expressed when he runs to his congeners after some time spent separated. He performs that behavior nose and ears pointing forward, his neck extended, front legs reaching out as much as the terrain allows. He does not slow down during that behavior, reaching with his front feet and adjusting his balance by the engagement of his hind legs. This posture always reflects the horse's intention to “go somewhere” and “do something specific”. It is a deliberate form of locomotion, not based in the momentum of a “cruising pace”. Even though the horse is throwing his weight on the forehand, the equilibrium remain mostly “uphill”.

In equestrian sports, this posture can be observed in racing, barrel racing, cutting, show-jumping or eventing as a result of an extrinsic motivator (competing with another horse, going to a fence or chasing a cow. It is much more difficult, if not impossible to achieve this posture that mimics natural impulsion by devising an intrinsic motivator (rider's aids—hands—legs—seat). Current equipment available to riders is designed to restrain and “frame” the horse with his head close to a vertical position (deemed necessary for balance and collection).

We posit that obtaining impulsion and eliminating the horse's natural resistance to the rider's aids is better achieved by getting him to mimic this natural behavior rather than using a whip on his hind legs or croup. Obtaining the advance of his head and front legs at will results in the horse gaining ground by that process. Once the front legs reach out in this natural way of initiating locomotion, the activation of the hind legs can be quickly perfected by supporting the natural “reciprocal diagonal reflex” common to many grazing quadrupeds.

On the contrary, horses are well-habituated with being bitten on the rump by others or kicked (mares can engage in lengthy and brutal “kicking duels”). Kicking out in response to the impact of a whip is the natural response that can be expected form a majority of horses, at least at the onset of training. The desired response to the whip (going forward on a minimal touch in a relaxed and confident manner by increased drive of the hind legs) requires a high degree of equestrian education not available to the majority of horse owners. A large number of riders will feely admit that horses easier resist the legs or whip with undesirable behaviors or plainly ignore them. A horse truly “in the legs” is a rare thing indeed.

The neurological explanation of relaxation during training. Additionally, It is also important that obtaining “forwardness” from the horse be achieved in relaxation (parasympathetic neurological state or “rest and digest mode”) and not in fear (sympathetic neurological state or “fight or flee mode”). The parasympathetic side of the autonomous nervous system is controlled in great part by the 2 vagus nerves (or nerves X) that come out of the skull and extend to the entire body, attaching themselves to the various organs. To simplify, they function as an on-switch for all the bodily functions that serve the long-term health needs of the organism. Here are the 2 most important ones that can be easily observed during training and are indispensable to the welfare, comfort and survival of the horse: Digestion, is dependent of regular vagal activity. It starts with salivating, chewing, swallowing, stomach activity, peristaltic motion of the intestines and evacuation. The horse is an herbivore that eats a low-calorie diet (grass or hay). He must eat 14 to 16 hours a day and maintain its digestion that entire time. Salivating, chewing, swallowing, gut activity (verifiable by “gut noises”) and regular evacuation must be maintained at all cost. Even if forage is provided continuously, a long or repeated interruption of this digestive process (usually due to stress arising from conflicts in the training process) creates anxiety (sympathetic state) that may eventually result in colic episode. Colic treatment is sometimes difficult, colic surgery is costly and the outcome creates long recovery situations or can even be fatal. Stress reduction (“Sympathetic Attenuation”) is triggered by vagal activity (lowering heart rate and breathing) and is evident by observing mouth activity: licking, chewing, yawning, as well as slower breathing and rapid eye movement.

Conversely, the stimulation of mouth's activity (salivation, chewing, swallowing) triggers relaxation and jumpstart or maintain the digestive process after a temporary interruption. It has been observed that horses in a herd manifest this oral behavior after a momentary conflict between dominant and subaltern animals. It is a way for both to restart their digestion and return to their main business which is to accumulate calories before winter or summer drought, or to feed a fetus or nurse a foal. It is well-known to horsemen (since Francois Baucher's writings circa 1850) that licking, chewing and swallowing are a clear and reliable sign of relaxation, which is the sine-qua-non condition for triggering the learning process. The gullet vagal trigger of the present invention, as described more fully below, triggers this response to aid in the training of the horse.

As the gullet vagal trigger acts on the horse's tongue in a completely unique and novel manner, it is important to understand the mechanisms it supports and reinforces. FIG 1a, 1b, 1c, and 1d, show the components of the horse's skull, the position of the floating Hyoid bone, and the muscles that attach to the Hyoid. The hyoid bone in horses is a Y-shaped structure of bones that supports the tongue, larynx, and pharynx. The hyoid bone also has multiple muscles attached to it, including the genioglossus, hyoglossus, and styloglossus. When these muscles contract, the position and shape of the hyoid apparatus can change, which in turn changes the position and shape of the larynx and nasopharynx. The hyoid apparatus is involved in a horse's senses of taste, hearing, and balance. It also plays a role in a horse's airway during exercise. The hyoid apparatus consists of a selection of small bones that articulate together. Its name hyoid means “shaped like the letter upsilon (Y)”, and it is situated at the base of the skull; between the cheeks of the horse. The hyoid apparatus connects to the skull via the temporohyoid joint.

Muscular Connections. The tongue connects to the hyoid apparatus. The hyoid apparatus has muscular connections from the throat to the forelimbs (omothyroid), as shown in FIG. 1b, shoulders (omohyoid) and sternum (sternohyoid) as shown in FIG. 1c. These muscles provide a direct connection from the hyoid apparatus to the shoulder of the horse via the ventral neck. Tension within these muscles results in restricted shoulder movement and the development of hypertonicity. Contraction of these muscles can put strain on the temporomandibular joint (TMJ). Additionally, hypertrophy and hypertonicity of the sternocephalic muscle can occur when the horse strains against the bit as a result of negative pressure upsetting the hyoid apparatus. The muscle chain (rust color) continues ventrally, connecting the pectoral area to the abdominal muscles, which are connected to the pelvic muscles.

Function of the Hyoid Apparatus. The series of bones in the hyoid apparatus are responsible for the suspension of the larynx and tongue from the skull. The main function of the hyoid is to support the tongue. It also places a role in maintaining the horse's safe equilibrium. Connection to the TMJ (Temporo-Mandibular Junction). Small muscles of the hyoid apparatus connect to the TMJ and the poll. The TMJ has a dual purpose of mastication and registering of postural information. Therefore, it is an important anatomical location for nerves that control proprioception and balance; the highest concentration of mechanoreceptors (sensory nerves that report any changes of the stimulating factors applied to a given area) are found in the periphery of the disc and at the attachment site of local ligaments. The TMJ articulates with the hyoid apparatus. The bones of the hyoid in the middle of the jaw connect all three main junctions of the horse. From the hyoid to the muscles of the scapula and the sternum up; from the hyoid to the occiput and from the poll to the nuchal ligament which then connects with the supraspinous ligament. When the long hyoid muscles present a pathology, it goes beyond TMJ pain, it affects the entire balance of the body. A contracted omohyoid muscle results in a retraction of the tongue back into the throat; interferes with the bit; locks the horse's jaw; limits lateral flexion; interferes with shoulder freedom and range of motion; and interferes with balance and proprioception. When these long muscles are contracted, they mimic the body's response to fear, as they are a part of the Fright and Flight Muscle Groups. When humans react to emotional stress, they tighten the neck muscles, clench their teeth, and hunch their shoulders. It's the same with horses.

Because of the importance of the hyoid in the animal's behavior, there have been a number of historical and previous solutions to horse training that manipulate the animal's mouth and tongue. Frenchman Francois Baucher (circa 1850) invented and described a methodology of manipulating the mouth and tongue with the reins to trigger this relaxation reflex, but it was entirely based on the use of the bit acting on the tongue from INSIDE the mouth. The Natural Horsemanship movement recognizes mouth activity as a proof of training success, but does not offer a direct, guaranteed method to provoke the vagal activity. J P Giacomini (the named inventor of the present application) invented a proprietary relaxation method, called Endotapping (1992 to present) that worked as a vagal trigger through a process of painless taps applied in different tempos and intensity. This method uses a long stick called an Endotapper, with a soft foam ball at its end that helps the trainer touch every part of the horse's body and relax the muscles of each area or initiate locomotion or modifies movement. It transforms the natural reflex (licking, salivating) into a conditioned reflex that can be provoked by a few finger taps. J P Giacomini has been granted a US patent for the Zeno Neuropacer device (U.S. Pat. No. 12,023,450 B2, issued on Jul. 2, 2024) that follows the Endotapping principle. It uses a particular algorithm that operates multiple simultaneous low-amplitude, low-intensity vibrating frequencies that reset the nervous system by scrambling existing neurological patterns and provide a clear opportunity to learn new ones. It can be triggered by various forms of physiological sensors (EKG for instance), controlled by a phone app and send direct notifications to the operator phone. The Zeno directly affects pain patterns, anxiety issues and creates rapid and lasting relaxation. This is relevant to the present patent application as the Zeno can be attached to any form of the present invention (halter, cavesson, bitless bridle and regular bitted bridle). The combined use of the Zeno with the gullet vagal trigger reduces previous patterns of tension and increases relaxation. The acquisition of the conditioned reflex is accelerated and its retention has proven to be much longer overtime.

Background information on vagus nerves' activity effect on brain waves. When stimulated, the vagus nerve is primarily associated with triggering of theta and alpha brain waves; research shows that increased vagus nerve activity correlates with increased power in these frequency bands, particularly in regions like the prefrontal cortex and amygdala, which are involved in mood regulation and stress response.

Key points about vagus nerve and brain waves. Frequency range: Studies have observed a direct correlation between vagus nerve activity and brain waves in the theta (4-7 Hz) and alpha (8-12 Hz) bands. Brain regions affected: The prefrontal cortex and amygdala are particularly responsive to vagus nerve stimulation, showing changes in theta and alpha activity when the nerve is activated. Calming effect: Increased vagus nerve activity is generally associated with a calming effect, which aligns with the theta and alpha brain wave patterns associated with relaxation. The gullet vagal trigger of the present application stimulates the vagus nerve mechanically by activating the swallowing action of the Hyoid and the production of saliva by the sublingual salivary glands. Manual tapping is frequently applied in the 4 to 10 Hz frequency, with some natural variability that increases its effect because it makes it harder for the body to block an unpredictable frequency. Zeno's simultaneous multi-frequency patterns of low-amplitude, low-intensity vibrations can be adjusted to a range of 4 Hz to 12 Hz, with each of its multiple motors adjusted to a random degree of variability. This algorithm creates a “frequency sweep” that is constantly changing, never repeated and most effective at stimulating the vagus nerves and fostering the Theta and Alpha waves responsible to a desirable calming effect. The combination of the manipulation of the vagus nerves in the present application, along with manual tapping and the addition of the Zeno device to the halter (which will vibrate the entire equipment) produces the most powerful relaxation effect on a horse during management, training and exercise.

### SUMMARY OF THE INVENTION

The invention is a modified halter to improve the training of a horse, and a method of using this modified halter to train the horse. The main component of the modified halter is the gullet vagal trigger that sits against the vagus nerve on the underside of the horse's head. This gullet vagal trigger is used in lieu of a standard bit, which prevents the possible harm to the animal's mouth. The gullet vagal trigger stimulates mouth movement of the animal, which relaxes the animal, and aids in training the animal. The halter also includes a set of ropes that run across the shoulders of the horse to stimulate the skin and muscles to further calm the animal which also aids in training the horse.

The invention also includes a method of training a horse using the modified halter with gullet vagal trigger. The method also employs the use of a specialized stick that is used to calm and trigger certain behaviors in the animal.

### BRIEF DESCRIPTION OF THE DRAWINGS

FIG. 1 is a side view showing standard horse tack.

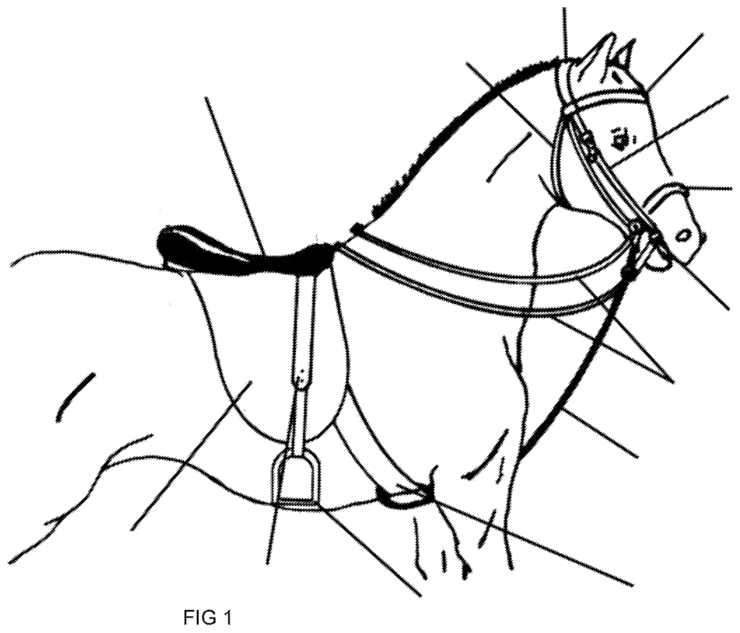

FIG. 2 is a side detailed view showing the standard head-gear of standard horse tack.

FIG. 3 is a perspective view of the vagal trigger.

FIG. 4 is a perspective view of the vagal trigger with lead lines attached.

FIG. 5 is a perspective view of the underside of a horses head with the vagal trigger attached.

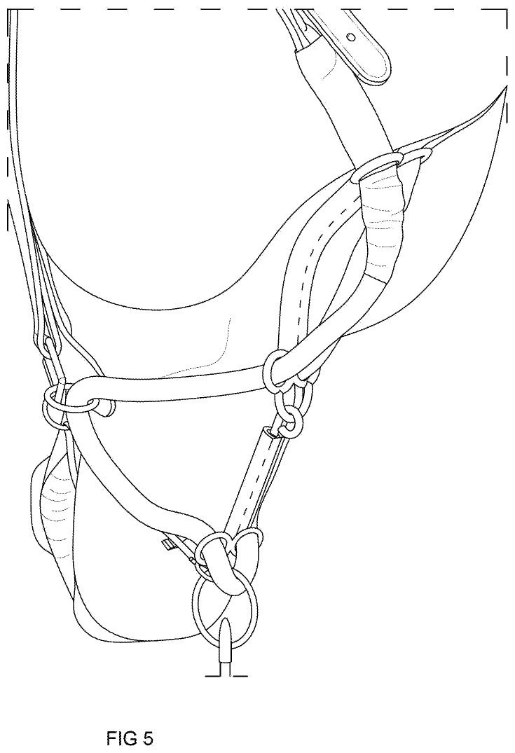

FIG. 6 is a side view of a horse with the vagal trigger attached to the head gear.

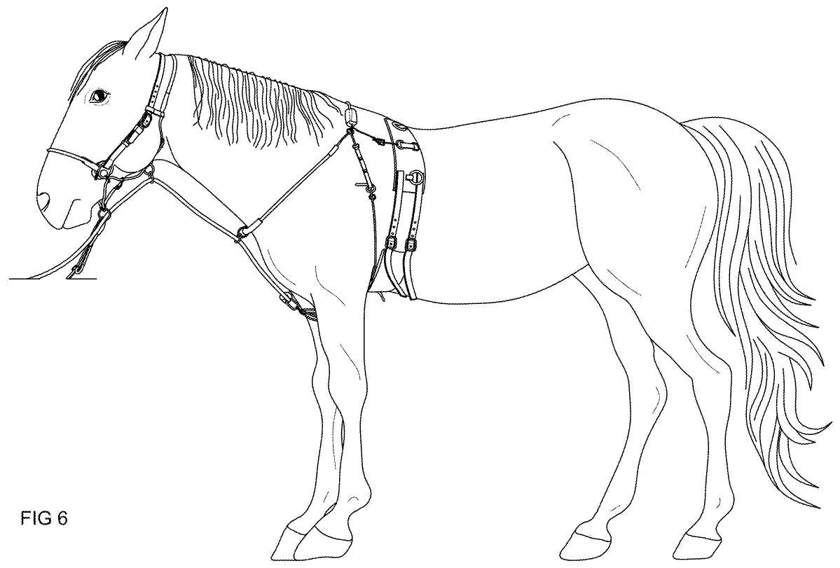

FIG. 7 is a side view of just the horse's head with the vagal trigger attached.

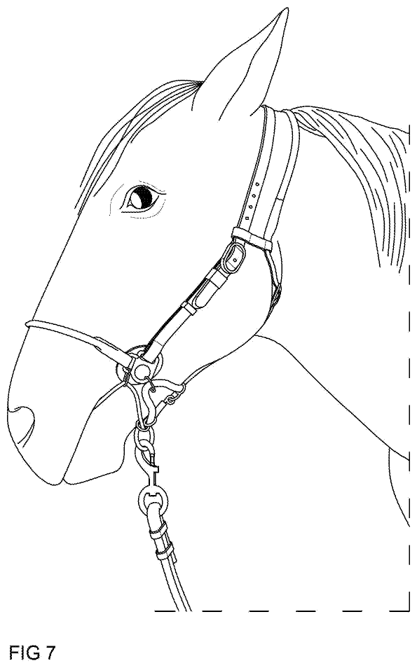

### DETAILED DESCRIPTION OF THE INVENTION

Detailed embodiments of the present invention are disclosed herein. It is to be understood that the disclosed embodiments are merely exemplary of the invention, and that there may be a variety of other alternate embodiments. The figures are not necessarily to scale, and some features may be exaggerated or minimized to show details of particular components. Therefore, specified structural and functional details disclosed herein are not to be interpreted as limiting, but merely as a basis for teaching one skilled in the art to employ the varying embodiments of the present invention.

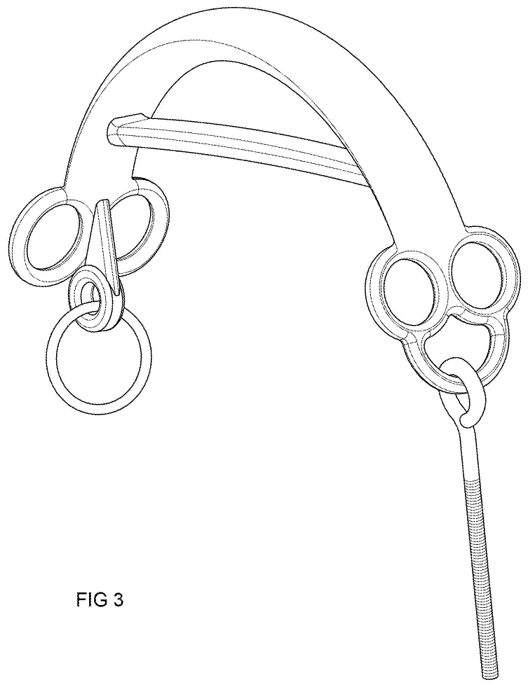

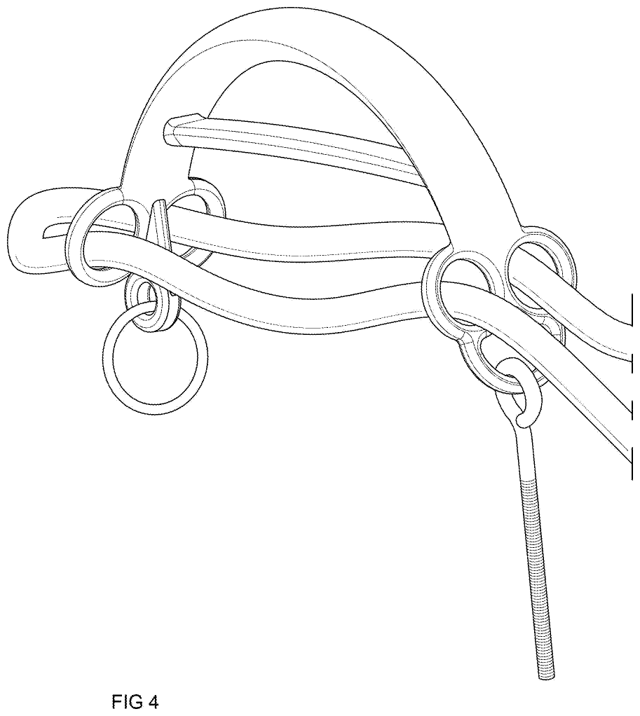

The present invention comprises the following components as shown in FIG. 3: A head piece (used for the halter, cavesson, all forms of bridles), that rest on the neck in the 2nd to 3rd cervical vertebra area (and not on the 1st vertebra as traditional headpieces do) of the horse. The headpiece is equipped with a little metal rod inside the crown that gives it a curved shape. This feature brings the lash end of the head piece over the neck automatically with a small impulse given by the handler, resolving the frequent problem of short handlers needing to fit the halter over the neck of tall horses and buckle it, or dealing with untrained horses who do not accept that the headpiece is slipped over their ears. A sliding rope forming a continuous loop that slides through various parts of the halter, cavesson or bridles and his buckled as an adjustable throat latch under the jowl of the animal. The combination head piece and throat latch is secured by one central keeper on the poll that keep the rope further back on the neck away from the poll, plus two sliding keepers of the same length (1 to 3 in.) that keep the cheek pieces of the halter, cavesson, bridle by sliding down to just above the side cheek buckles. This positions the equipment far away from the ears, the majority of facial nerves, the temporomandibular joint (TMJ) and all its delicate neural endings, as shown in FIG. 4. The rope applies a very mild forward pressure behind and under the jowl that persuades the horse to advance his head forward and arch his neck in natural position. It then triggers the immediate lift of one front leg forward and up. The reciprocal diagonal reflex of the horse make him lift his hindleg soon after (creating a near diagonal step that is considered desirable by all equestrian disciplines for the purpose of activating the back swing and prepares for collection and improved balance. Both with a marked increased range of motion (compared with the animal usual standard of movement. The rope (on the buckle side of the throatlatch of the halter (left of the horse), runs through the left side of the Gullet Vagal trigger (described below), the left “side square” of the halter, the left ring of the directional rod, the leading ring (to which the lead rope or lunge line is attached) and returns though the right ring of the directional rod, the right “square” of the halter, the right rings of the gullet vagal triggers, the 3 keepers of the crown piece and ends with the tongue end of the throat latch.

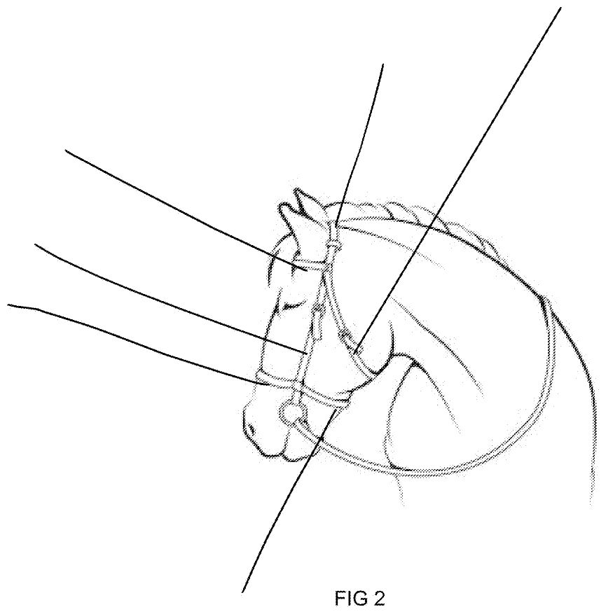

A gullet vagal trigger device, shown in FIG. 2, consisting of an upwardly convex leather-covered metal or plastic piece that applies a very mild upward pressure in the throat gullet (under the tongue) near the vagus nerve, and thus encourages tongue lifting, swallowing by activating the Hyoid apparatus that stimulates a group of muscles and stimulates salivation. In alternate embodiments the gullet vagal trigger can be made of any semi-flexible material, and covered with a protective material that both protects the device and protects the animal from injury. All these effects are directly related to vagal activity and its triggering effect on the parasympathetic nervous system. Relaxation states originating in vagal activity produce the corresponding brain waves. The gullet vagal trigger's action is unique in the entire equestrian literature. It replaces a long series of methods that are considerably more complicated, harder to use successfully by amateur horse owners, and in the end, less effective. The gullet vagal trigger is integrated into the halter of the present invention, or can be added on its own to an existing bridle that includes an adequate throatlatch.

The gullet vagal trigger activates the tongue activity, as described in the Background above, the hyoid apparatus, and the entire muscular system that the hyoid is attached to. The gullet vagal trigger works on textbook physiological functions. It lifts the tongue, activates sublingual salivary glands and triggers the hyoid function. It facilitates breathing and swallowing by stimulating the muscles that activate the Hyoid apparatus (around the larynx). It immediately improves the locomotion of the horse by stretching the neck forward in a desirable arched shape, and provokes ample, forward steps without resistance. It provokes a better equilibrium by bringing all 4 feet further ahead of their stance position (vertical), which is the way balance is regained at every step for bipeds and quadrupeds. It mimics well-known the ethological principle of the horse most important priority: rejoining his congeners in the quickest possible way with a strong intention expressed by a vigorous, deliberate gait. It produces a repeatable automatic result and its effects are cumulative: the more you use it, the faster it works. It does not require the trainer to place any object in the horse's mouth, so it can be used at any age of the horse, including for foals' halter training. By painlessly lifting the tongue, the gullet vagal trigger replaces previous horse control methods from the ground or under the saddle, and develops a correct muscular connection through the entire body of the horse.

There are a series of ropes that attach to the saddle to stimulate the shoulders of the animal. This shoulder stimulator consists of a loose loop or rope attached to the saddle by its upper Ds (near the withers) and hanging loose following the girth line, as seen in FIG. 8 and FIG. 9. By attaching it near the withers, the shoulder stimulator swing back and forth with the pendulum of the shoulders. Its purpose is to gently nudge the elbows of the horse to activate the brachiocephalic muscle's activity from the bottom. The Brachiocephalic is a mainly superficial muscle located in underside of the horse's neck. This muscle has multiple functions that are extremely important to the correct posture and locomotion of the horse: It laterally inclines the head and neck to the same side of contraction (lateral flexion and downwards stretch). It draws the front limb forward when the head is in a fixed position, in order to increase the forward range of motion of the front legs. It extends the head and neck when the limb is fixed, lengthening the neck posture in an arched shape. As such, the Brachiocephalic is extremely important to the proper shoulder and front limb action as well as lateral flexion. By doing so, the Brachiocephalic acts as an antagonist to the Trapezius Cervicus which is the muscle mainly responsible for the toxic inversion of the neck.

The shoulder stimulator is fully integrated with the halter of the present invention. While the purpose of the head piece of the present invention is to pull the head forward and provoke the lift of the front legs, the shoulder stimulator encourages that lift, increases its effect by messaging the mechanoreceptors in the elbows skin, evens out the natural dissymmetry of the gait, advantageously replaces the rider's leg action and creates a buffer between the mobile attachment at the center of the chest and the head piece equipment, avoiding any form of blockage that occurs when equipment is attached to a fixed point such as the girth. The arching of the neck and the advance of the front legs facilitate impulsion, improves balance and engages the ventral Vagal nexus that is responsible for social engagement. Shoulder stimulator material: the loop is made of a round, smooth, slick, cord-like sliding material in order to never rub the sensitive skin behind the elbows. It has a central elastic attachment placed between the front legs through a sliding ring, to replace the central ring that can be found in the center of most modern girthing systems to which different forms of equipment are attached: Attachments for lunging, one end of the double-clip lunge line will be used in conjunction, the other end being directly clipped on the head piece used (halter, cavesson, bridle).

The method of training a horse uses the above components, but also includes a specialized stick with a ball attached to the end, called an Endotapper stick. This is used for either relaxation or stimulation of legs and muscle groups and induce longer, quicker, symmetrical range of motion in the horse's locomotion. The method of training a horse describe herein addresses the causes of the fundamental horsemanship problem of accessing relaxation at its root. It is applicable in any situation: the horse being, led, tied to a ring or in cross ties, groomed, shod, treated medically, loaded in a trailer, trained, ridden in any situation or warmed up at a horse show (depending on current rules).

Methodology for teaching to lead: a double headed line that extends forward, passes through a ring hanging from the halter at the chin level, extend in front of the head, goes through a floating ring to which a lead line is attached that goes to the hand of the handler, and then returns to the acting ring of the halter. This system distributes the forward pulling action of the handler in a self-adjusting mode between the pressure on the back of the jowl and the back of the elbows. At the beginning of the training process (young horses or retraining older ones), it is recommended to use the Endotapper Stick and tap the back of the front legs rhythmically to induce forwardness and unlock the “Stay apparatus” that the horse uses reflexively to lock his knee joints. The 4 combined actions: jowl pressure, tongue lift, elbow pressure and front leg tapping address all the causes of

Methodology for lunging. With one end of the double-ended lunge line attached to the front of the head piece of the halter/cavesson/bridle, the other end of the lunge line can slide through the bit/cavesson side ring and attached to the shoulder stimulator center ring, the shoulder stimulator Inside Floating ring, and the shoulder stimulator outside floating ring. These mode of action isolate and increase the range of motion of either front legs in either directions. It is important for horses who need correction of their asymmetrical gaits.

Associating the modified halter with gullet vagal trigger (known herein as the “com'along system”) with the shoulder stimulating rope and the endotapper training stick to form a complete training system, eliminate resistance and produce controlled impulsion on demand. To link the Com' Along Halter forward effect on the head with the Shoulder Stim forward effect on the elbows/shoulders, the operator needs to combine the different physical parts of the apparatus and harmonize the methodology, as follows: Use a double headed line (one snap at each end) that extends forward; Snap one end to the leading ring of the halter (ring A); passes through a permanent ring floating on the double-ended line (to which the lead line will be snapped on) (Ring B) and that goes to the hand of the handler; Passes through Ring A again (hanging from the halter at the chin level), going toward the horse's chest; Passes through an additional ring under the throat latch (ring C), going toward the horse's chest; Passes downward through a ring hanging from the middle of the breastplate (ring D); Snaps on to the ring floating on the middle of the Shoulder stim (ring E). This Double-Ended rope with a floating ring system (ring B) distributes the forward pulling action of the handler with a self-adjusting mode between the pressure on the back of the jowl applied by the throatlatch and to a lesser degree by the Gullet Vagal Trigger with the pressure at the back of the elbows. The maximum pressure of the Shoulder Stim is only applied to one elbow at a time when the leg is in stance (foot on the ground) to stimulate its timely lift. On the other side (the leg that is moving forward in the air), the Shoulder Stim follows the elbow forward progression in a non-rubbing way and guide it to improve its range of motion (known as semi-assisted movement in physiotherapy). At the beginning of the training process (young horses or retraining older ones), it is recommended to use the Endotapper Stick and tap the back of the front legs rhythmically to induce forwardness and unlock the “Stay apparatus” that the horse uses reflexively to lock his knee and stifle joints. This is very important because a strongly resisting horse dot not relate “the problem” (pressure on the throat latch) with the proposed solution (lifting one foot first and initiate locomotion). The touch of the Endotapper on various part of the body stimulates specialized “mechanoreceptors” (see below for scientific meaning). Massage is static and separate from movement. Movement is dynamic and separate from touch. Endotapping, or use of the endotapper stick, integrate the two together in a complete new way that considerably amplifies the language of the aids by creating particular responses from specific actions. Each sensation the horse determines a predetermined response that can be exploited opportunistically by the trainer. Other desired responses are unnatural at first, they have to be modified by association with positive pressure mode.

The 4 combined actions: jowl pressure, tongue lift, elbow pressure and front leg tapping address all the physical, emotional and cognitive (own life experiences-created behaviors) causes of the horse natural resistance to impulsion demands. The neurological process is always the same: 1. Resist the stimulus (opposition reflex), 2. Ignore the stimulus (habituation), 3. Trigger relaxation (the parasympathetic mode governed by the Vagus nerve), 4. learn a new information in the correct mode (relaxed movement with increased range of movement), 5. Turn the natural reaction into a learned/conditioned/systematic response that creates a new muscle memory. The iteration of this information (known in part but not to be found in current science as a sequence) is part of my Zeno Neuropacer patent already mentioned.

Science: The stay apparatus consists of a series of muscles, ligaments, and tendons in the equine thoracic and pelvic limbs, that stabilize the limb in a standing or weight bearing position. Ligaments and tendons are resistant to fatigue and can lock or hold joints into a weightbearing position. The horse uses it to stay up and not fall when landing on one foot at each stride. Horse also uses it when refusing to go forward on demand or when preparing for defensive behavior (kicking, bucking, rearing).

Mechanoreceptors are an important receptor class for the somatosensory system that detect and convert mechanical energy from the environment into adequate responses. They are biologic transducers for conversion of the mechanical energy of various forms of touch into specific nerve impulses that the central nervous system can process immediately. They contain primary sensory neurons that respond to changes in mechanical displacement. The information goes 80% body to brain and only 20% brain to body. For them to work efficiently, they need direct, localized, timed touch that addresses a particular muscle (or the agonist-antagonist pair of muscles that controls joint function) for the purpose of modifying a particular phase of the movement (think about changing a golf swing, a tennis backend or reeducating a stroke patient).

This is the basis for The Com' Along/Shoulder Stim/Endotapper combination of effects. It explains why it is (near) immediately effective in transforming the horse locomotion and behavior (the latter depends on the former for its modification). Mechanoreceptors have many functions, including but not limited to: Tactile feedback—Mechanoreceptors in the skin allow us to sense (and differentiate automatically) touch, pressure, vibration, and cutaneous tension. They are essential for human (and equine training) development and sensation; Balance—Hair follicle endings act as mechanoreceptors to sense the direction a hair is pointing. This is especially important in the ear, where the position of tiny hairs helps with balance though the proprioception sense; Muscle movement—Mechanoreceptors in muscles, such as muscle spindles, help with the stretch reflex. When a muscle is stretched, impulses are carried back to the muscle to cause it to contract. Same goes for the Golgi organ that, controls that contraction when it is excessive and protect muscle, joints and ligaments from overexertion.

Methodology for Lunging: Follow the same system for lunging as for leading/general training in order to link the Com' Along halter forward effect on the head with the shoulder stim forward effect on the elbows/shoulders. This mode of action isolates and increases the range of motion of either front leg in both directions. It is important for horses who need correction of their asymmetrical gaits (which is the majority due to innate asymmetrical posture and movement). The reciprocal diagonal reflex (meaning that when one front leg lifts off and moves forward, the diagonal hind leg follows in the same form and eventually to the same degree. Influencing the frontend biomechanics is the surest and fastest way to modify positively the corresponding movements of the hind end. Contrary to traditional equestrian dogma, the reverse is neurologically false. The Shoulder stim can be associated directly with every other form of training headgear normally used when lunging: the Com'Along Halter, any of the Com'Along Lunging Cavessons, any of the Com' Along bridles.

Protocol to teach the horse the proper response with the modified halter. a. Place yourself squarely in front of the horse and apply a steady pressure forward (or slightly sideways) with the lead rope, while clucking to the horse and stepping backward in the same direction as you request the horse to go. It is important that the handler applies the pressure before s/he moves his/her feet and does not release the pressure: it is for the horse to yield and relax the lead rope by stepping forward with a quicker step at first and a longer stride eventually. b. In the rare occurrence the horse pulls back by inverting his neck, maintain the pressure calmly and firmly with a Whoa! verbal message. Gently move the head of the horse left and right to relax the neck and help the process. c. Resume the lesson by pulling the lead line at a greater sideways angle and use a stick to softly touch the back or the side of the front leg standing further back (choose the one most likely to move forward next so it picks up and move forward. A few attempts to the left, the right and eventually straight ahead are enough to establish the Com' Along reflex permanently. d. If the horse inverts his neck in any way when pulled forward, keep practicing the leading exercise on straight and turns, halting and starting, stimulating the timely lift of the front feet, until the neck arches when moving forward. You will observe that the quicker the front legs lift on the Com' Along pull, the quicker the hind feet are going to step up and forward. When the horse freezes, use fast/soft tapping on the leg that braces until it relaxes and unlock. Can also tap on back, shoulders and neck to relax the topline. Resume forward after that. e. Make sure to reward the horse verbally every time he yields forward. Pull him straight to your chest with his head square and pat him generously. Practice frequent backing with a higher hand and a few taps on the front legs, then pull the lead line forward again. This teaches the horse not to pull back when tied. f. For all potentially difficult situations (loading, tying, jumping), make sure that the Com'Along forward foundation has been well-established.

I claim:

1. A modified halter to aid in training horses, said modified halter comprising:
a headpiece attachable to a horse, said head piece including a curved gullet vagal trigger that presses against the vagus nerve of the horse when the headpiece is attached to stimulate the vagus nerve of the horse, wherein the stimulation of the vagus nerve relaxes the animal to make it more receptive for training.

2. The modified halter of claim 1 further comprising a series of ropes attached to said headpiece, wherein the ropes hang over the shoulders of the horse to provide additional stimulation to aid in the training of the horse.

3. A method of training a horse that comprises:
providing a modified halter having a modified headpiece, said modified headpiece including a curved gullet vagal trigger that rests against the vagus nerve of the horse when the headpiece is attached to the horse;
placing the modified headpiece on a horse and positioning the gullet vagal trigger under the head of the horse so that the gullet vagal trigger presses against the vagus nerve of the horse;
attaching ropes to the halter that hang over the horses shoulders to stimulate the horse;
providing a stick modified with a ball attachment to stimulate the legs of the horse;
training the horse.
